(19) United States
(12) Patent Application Publication
(10) Pub. No.: US 2025/0259772 A1
(43) Pub. Date: Aug. 14, 2025

(54) TRANSFORMER CONTAINMENT BAG WITH COVER AND METHOD TO CONTAIN AND FACILITATE LIFTING OF INDUSTRIAL EQUIPMENT CONTAINED THEREIN

(71) Applicant: Andax Industries, L.L.C., Saint Marys, KS (US)

(72) Inventors: Patrick F. McAtarian, Saint Marys, KS (US); Mark McAtarian, Saint Marys, KS (US)

(73) Assignee: Andax Industries, L.L.C., Saint Marys, KS (US)

(21) Appl. No.: 18/438,295

(22) Filed: Feb. 9, 2024

(51) Int. Cl. H01F 27/02; H01F 27/00; H01F 27/06

(52) U.S. Cl. CPC H01F 27/022; H01F 27/002; H01F 27/06

(57) ABSTRACT

A method to contain and facilitate lifting of industrial equipment includes placing the equipment in an open top container of a containment bag assembly. The container is coupled to the equipment so that the equipment supports the container when the equipment is lifted. The equipment and an open top of the container is covered with a cover. The cover is secured to the container so as to cooperatively provide weather protection to the equipment. Furthermore, the cover may be unsecured from the container and the equipment and open top may be partially uncovered so that a lifting element of the equipment is exposed.

### BACKGROUND

The present invention relates generally to an industrial equipment containment bag assembly for transporting and storage of industrial equipment, such as electrical transformers.

Conventional electrical transformers include a sealed, oil-filled tank with internal electrical components, such as transformer coils. These transformers also have external hardware, such as mounting equipment, connection busses, and lifting lugs. Traditional transformers are subject to leaking over time, resulting from damage to the transformer tank or from extended use. Such leakages can be environmentally damaging, inasmuch as the oil formulations within the transformers can often include hazardous chemicals (e.g., PCBs). It is necessary to safely contain, store, and transport failed transformers for disposal or repair, in accordance with governmental regulations. In like manner, other types of industrial equipment, and especially electrical utility equipment, require safe and effective containment, storage, and shipping enclosures.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a method to contain and facilitate lifting of industrial equipment is provided. The equipment includes a lifting element. The method includes placing the equipment in an open top container of a containment bag assembly. The method also includes coupling the container to the equipment so that the equipment supports the container when the equipment is lifted. Furthermore, the method includes covering the equipment and open top of the container with a cover. Additionally, the method includes securing the cover to the container so as to cooperatively provide weather protection to the equipment. In addition, the method includes un-securing the cover from the container and partially uncovering the equipment and open top so that the lifting element is exposed.

In another aspect, an equipment containment bag assembly is provided. The containment bag assembly contains and facilitates lifting of industrial equipment. The equipment containment bag assembly includes a container having an interior chamber and an open top through which the industrial equipment passes into the interior chamber. The container includes a base wall, an upright wall extending upwardly from the base wall, and a connection assembly including an attachment strap connected to the upright wall. The containment bag assembly also includes a support strap configured to extend over the equipment when in the interior chamber. The support strap is releasably coupled to the attachment strap to removably connect the support strap to the container, such that the support strap supports the container on the equipment in the interior chamber when the equipment is lifted. The containment bag assembly also includes a cover removably covering the open top of the container. The cover includes a cover strap releasably coupled to the attachment strap to removably connect the cover to the container.

A variety of additional aspects will be set forth in the detailed description that follows. These aspects can relate to individual features and to combinations of features. Advantages of these and other aspects will be apparent to those skilled in the art from the following description of the exemplary embodiments which have been shown and described by way of illustration. As will be realized, the details of the present aspects described herein may be modified in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a top perspective of an equipment containment bag assembly, in accordance with an embodiment of the present invention;

FIG. 2 is a bottom perspective of the equipment containment bag assembly of FIG. 1;

FIG. 3 is an exploded perspective of the equipment containment bag assembly of FIGS. 1 and 2;

FIG. 4 is an enlarged section view of a two-stage connection assembly of the equipment containment bag assembly of FIGS. 1-3, taken about line 4-4 of FIG. 1;

FIG. 5 is an enlarged view of a cover strap of the two-stage connection assembly depicted in FIG. 3;

FIG. 6 is an enlarged view of an end of a support strap depicted in FIG. 3;

FIG. 7 is an enlarged view of a container connection assembly of the two-stage connection assembly depicted in FIG. 3;

FIG. 8 is a perspective of the equipment containment bag assembly of FIGS. 1-3, showing a piece of industrial equipment being placed therein;

FIG. 9 is a perspective of the equipment containment bag assembly having the industrial equipment contained therein and a plurality of support straps attached thereto; and

FIG. 10 is a perspective of the equipment containment bag assembly showing a cover partially uncovering the industrial equipment contained therein to provide access to lifting elements of the industrial equipment.

Unless otherwise indicated, the drawing figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein. While the drawings do not necessarily provide exact dimensions or tolerances for the illustrated components or structures, the drawings are to scale with respect to the relationships between the components of the structures illustrated in the drawings.

### DETAILED DESCRIPTION

The following detailed description of embodiments of the disclosure references the accompanying figures. The embodiments are intended to describe aspects of the disclosure in sufficient detail to enable those with ordinary skill in the art to practice the disclosure. The embodiments of the disclosure are illustrated by way of example and not by way of limitation. Other embodiments may be utilized, and changes may be made without departing from the scope of the claims. The following description is, therefore, not limiting. The scope of the present disclosure is defined only by the appended claims, along with the full scope of equivalents to which such claims are entitled.

The embodiments are particularly designed for use with equipment such as electrical transformers, which are universally provided with a lifting element, which in most instances includes a pair of opposed, side-mounted lifting elements. However, according to some aspects of the present disclosure, the lifting element may be alternatively configured without departing from the scope of the present disclosure. For example, some industrial equipment may include a single, centrally located eyelet for lifting.

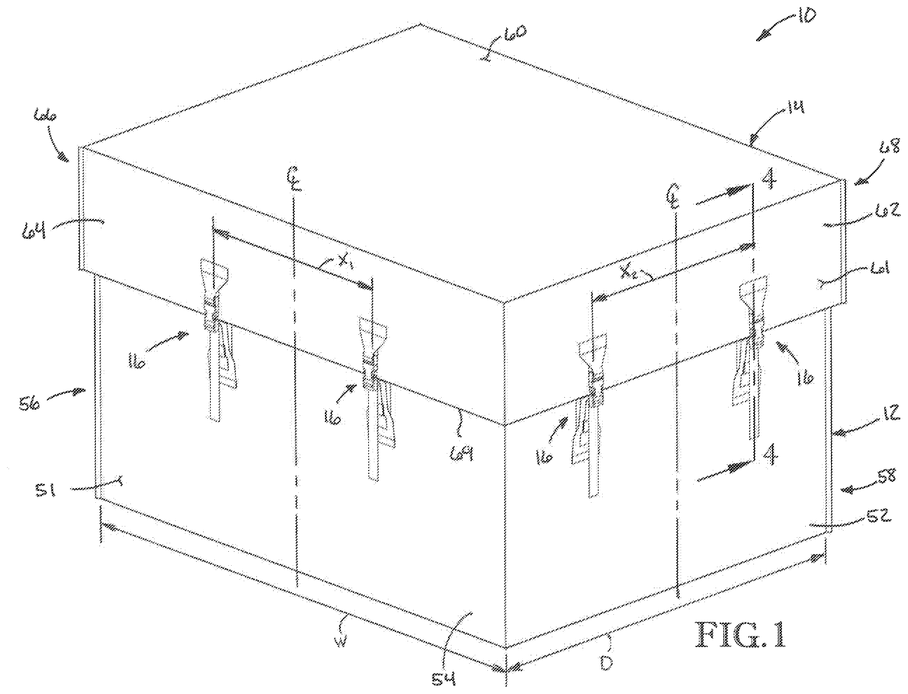

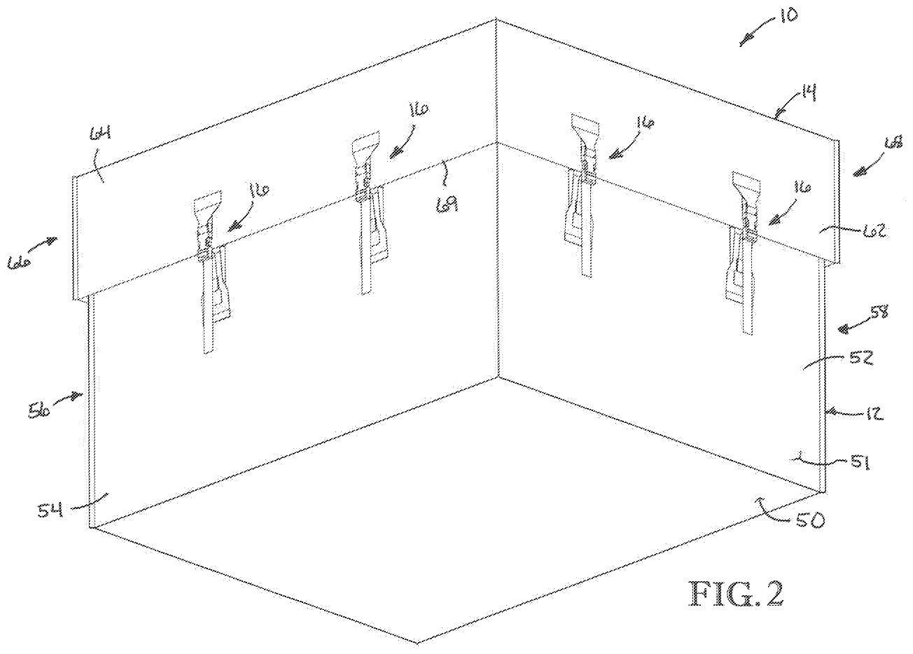

Turning now to FIGS. 1-4, an industrial equipment containment bag assembly 10 is depicted. The industrial equipment containment bag assembly 10 broadly includes an upright, cuboid-shaped (i.e., a rectangular prism-shaped), open top container 12, one or more support straps 20, and a generally cuboid-shaped cover 14. The industrial equipment containment bag assembly 10 includes a plurality of two-stage connection assemblies 16. In the example, the industrial equipment containment bag assembly 10 is multisided and generally includes two (2) two-stage connection assemblies 16 on each side of the industrial equipment containment bag assembly 10.

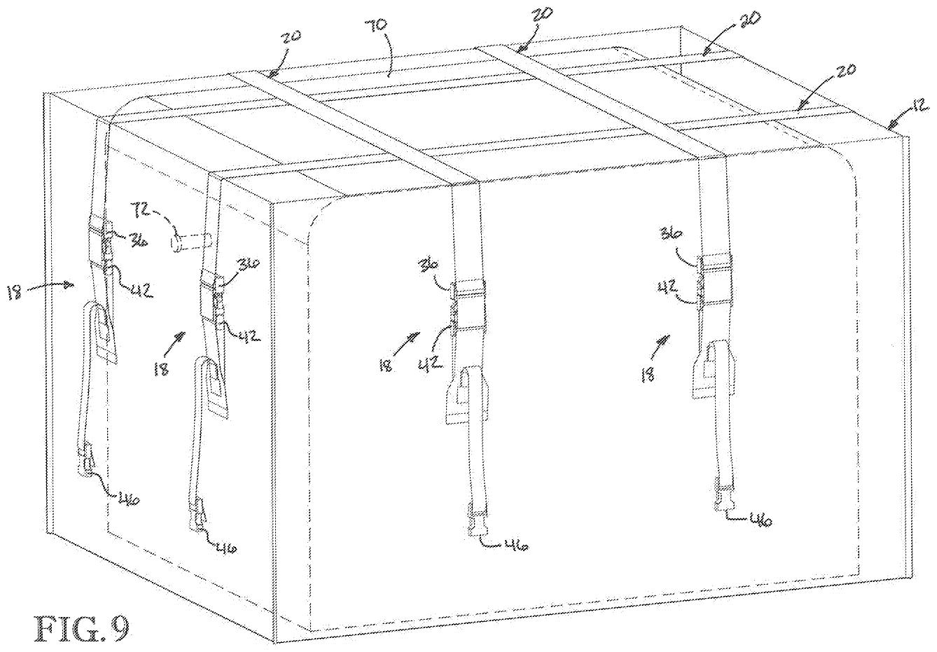

The container 12 includes a base wall 50 and an upwardly extending upright wall 51. In the example, the upright wall 51 is multisided, although in certain aspects of the invention, the upright wall may be a generally tubular, continuous wall. As depicted in FIGS. 1-3, the upright wall 51 includes four (4) upright walls 52, 54, 56, and 58. The upright walls 52, 54, 56, and 58 are generally perpendicular to each other and terminate in an upper edge 59. The upper edge 59 defines the open top of the container 12. The container 12 may be fabricated from any suitable material, but is preferably fabricated from a liquid-resistant flexible material, such as a heavy-duty synthetic resin material, and is configured to be substantially leak proof. As explained further herein, one of the functions of the container 12 is to contain any spillage of liquid or other contaminants from one or more pieces of industrial equipment, such as an electrical transformer 70, contained within an interior chamber 24 defined in the container 12 (see FIG. 9). As illustrated in FIG. 9, the electrical transformer 70 (i.e., exemplary industrial equipment) may be received within the interior chamber 24 of the container 12.

In an embodiment, the container 12 is configured to function at a temperature down to and including negative forty degrees Fahrenheit (−40° F.). Furthermore, the container 12 is configured to hold a minimum of three hundred pounds (300 lbs.) of liquid, materials, or contaminants while remaining securely attached to the electrical transformer 70. In a more preferred embodiment, the container 12 is configured to hold a minimum of four hundred pounds (400 lbs.) of liquid, materials, or contaminants. In a most preferred embodiment, the container 12 is configured to hold a minimum of nine hundred pounds (900 lbs.) of liquid, materials, or contaminants while remaining securely attached to the electrical transformer 70.

Referring back to FIGS. 1-4, in the example, the container 12 is generally a symmetric rectangular prism. That is, the container 12 is symmetric front to back and side to side. However, according to certain aspects of the present invention, the container 12 may be fabricated in any shape and/or form, including asymmetric shapes and forms.

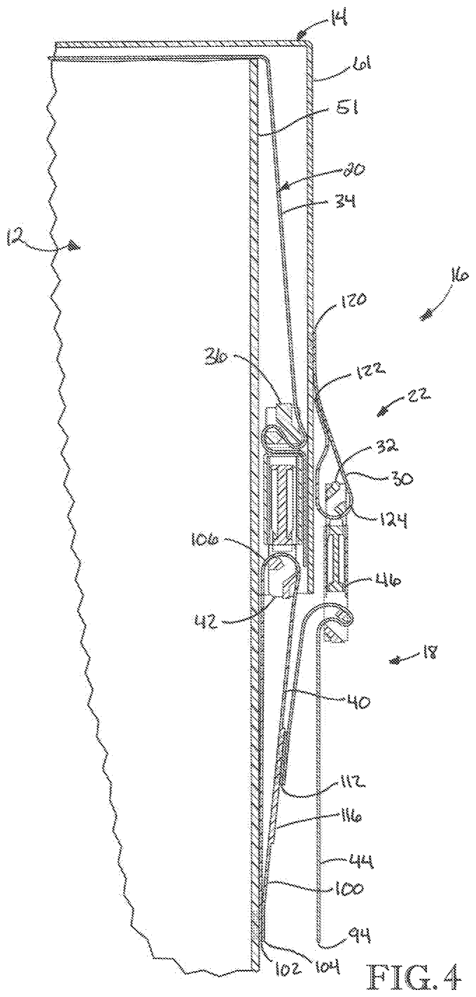

In the example, the base wall 50 and upright walls 52, 54, 56, and 58 are formed from a single blank of sheet material. The upright walls 52, 54, 56, and 58 are folded with respect to the base wall 50 at an angle of about ninety degrees (90°) to define upwardly extending upright walls relative to the base wall 50. As depicted in FIG. 4, edges of adjacent upright walls are attached to each other to form the open top container 12 and define the interior chamber 24. For example, a first edge of the upright wall 52 may be attached to an adjacent first edge of the upright wall 54 to form a leak-proof seam 80, a second edge of the upright wall 54 may be attached to an adjacent first edge of the upright wall 56 to form a leak-proof seam 82, a second edge of the upright wall 56 may be attached to an adjacent first edge of the upright wall 58 to form a leak-proof seam 84, and a second edge of the upright wall 58 may be attached to an adjacent second edge of the upright wall 52 to form a leak-proof seam 86.

While described above as being fabricated from a single blank of sheet material, it is noted that the container 12 may alternatively be fabricated from a plurality of blanks. For example, the base wall 50 may be separate from the upright wall 51, such as the upright walls 52, 54, 56, and 58. In such an embodiment, the base wall 50 may be attached to the upright wall, such as each of the upright walls 52, 54, 56, and 58, at a leak-proof seam in a substantially similar manner as the upright walls are attached to each other, as described above. Additionally, the base wall and/or any of the upright walls may be fabricated from multiple blanks of sheet material, wherein the blanks are attached together at one or more leak-proof seams to form the respective base wall or upright wall.

In the example embodiment, the leak-proof seams 80, 82, 84, and 86 are formed by heat welding or fusion bonding. Heat welding generally involves using heat to melt the sheet material at the respective seam, allowing the two upright wall edges to fuse together. Typically, specialized welding equipment, such as hot air, ultrasonic welders, radio frequency welders, etc., are used to achieve such leak-proof seams. The heat welds at the seams 80, 82, 84, and 86 (or some other connection means, as discussed above) are provided to fix, connect, or secure the base wall 50 and the upright walls 52, 54, 56, and 58 to one another. The heat welds are preferably configured to resist peel forces and facilitate transfer of shear forces between the base wall 50 and the upright walls 52, 54, 56, and 58. In alternative embodiments, the leak-proof seams 80, 82, 84, and 86 may be formed by any method that enables the container 12 to function as described herein, including, for example, stitching, adhesive bonding, combinations of any of the above examples, and the like.

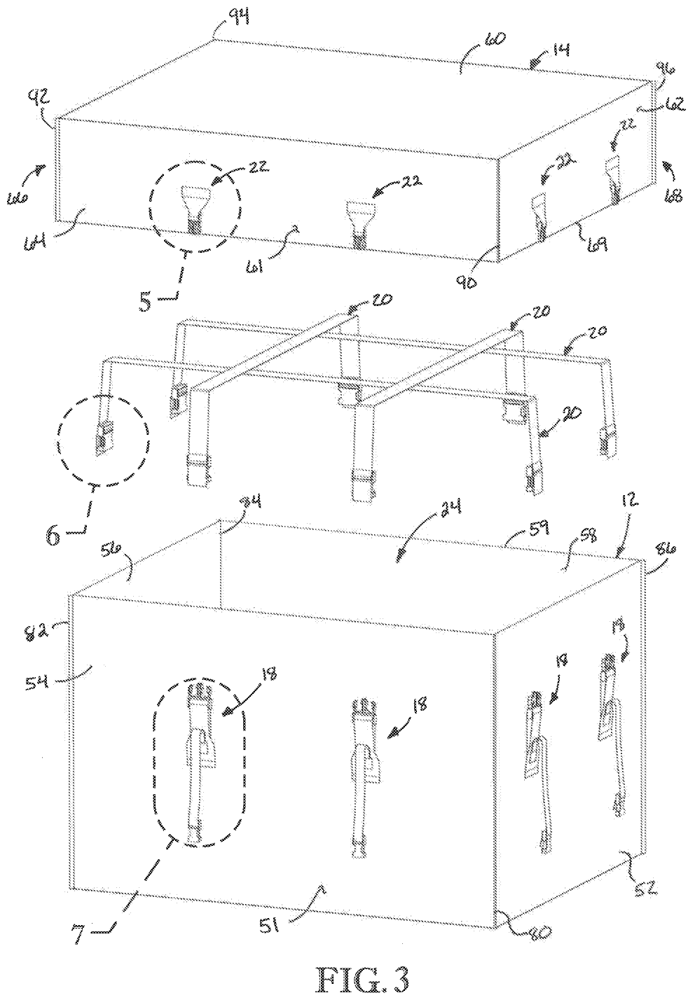

Referring to FIGS. 3 and 4, each two-stage connection assembly 16 includes a container connection assembly 18. Each container connection assembly 18 is attached to the upright wall 51 of the container 12. In the exemplary embodiment, the upright wall 51 includes the upright walls 52, 54, 56, and 58. Each of the upright walls 52, 54, 56, and 58 have at least one container connection assembly 18 attached thereto. It is noted, however, that the figures are exemplary only and that the container 12 may include any number of container connection assemblies 18 arranged along the upright wall(s) in any manner that enables the industrial equipment containment bag assembly 10 to function as described herein. In a preferred embodiment, the container 12 includes two (2) container connection assemblies 18 on each of the four (4) upright walls 52, 54, 56, and 58. The two (2) container connection assemblies 18 may be generally centered about a centerline of the upright wall and laterally spaced along a width “W” or depth “D” of the upright wall a distance “X₁” or “X₂” that is in a range between and including about thirty-five percent (35%) to about fifty-five percent (55%) of a total width “W” or depth “D” of the respective upright wall.

Each container connection assembly 18 includes an attachment strap 40 connected to the upright wall 51. The attachment strap 40 include an elongated looped body 100 having opposite first and second ends 102 and 104. As illustrated in FIG. 4, the ends 102 and 104 terminate adjacent to each other, defining a loop 106 intermediate the ends 102 and 104. The first and second ends 102 and 104 are secured to the upright wall 51 by heat welding, fusion bonding, stitching, adhesive bonding, combinations of any of the above examples, and/or by any other method that enables the container 12 to function as described herein. In the example embodiment, the elongated body 100 is fabricated from any suitable material but is preferably fabricated from the same material as the container 12 (i.e., a liquid-resistant flexible material, such as a heavy-duty synthetic resin material).

The container connection assembly 18 includes a first connection member 42 slidably coupled to the attachment strap 40. In particular, the first connection member 42 is captured by and slidable relative to the loop 106 defined by the looped body 100. In the example embodiment, the first connection member 42 includes a male component of a first releasable snap-fit connector assembly. Alternatively, the first connection member 42 may include any component of a releasable connector assembly that enables the containment bag assembly 10 to function as described herein.

The container connection assembly 18 also includes a connection strap 44. The connection strap 44 includes an elongated body 110 having opposite first and second connection strap ends 112 and 114. The connection strap 44 also includes a connection portion 116, which is attached to one of the first and second connection strap ends 112 and 114. The connection portion 116 is attached to the connection strap end, such as end 112, via stitching, heat welding, fusion bonding, adhesive bonding, combinations of any of the above examples, and/or by any other method that enables the container 12 to function as described herein. Furthermore, the connection portion 116 is attached to the elongated looped body 100 of the attachment strap 40 via heat welding, fusion bonding, stitching, adhesive bonding, combinations of any of the above examples, and/or by any other method that enables the container 12 to function as described herein. In the example embodiment, the connection portion 116 is fabricated from any suitable material but is preferably fabricated from the same material as the container 12 (i.e., a liquid-resistant flexible material, such as a heavy-duty synthetic resin material). In addition, the elongated body 110 is fabricated from any suitable material but is preferably fabricated from a flexible woven webbing material.

The container connection assembly 18 includes a second connection member 46 slidably coupled to the connection strap 44. In particular, the connection strap end 114 opposite the connection portion 116 is looped through the second connection member 46 to provide a sliding arrangement therebetween, which enables adjustment of the span of length of the connection strap 44 as the connection strap 44 attaches to the cover 14, as described further herein. In the example embodiment, the second connection member 46 includes a female component of a second releasable snap-fit connector assembly. Alternatively, the second connection member 46 may include any component of a releasable connector assembly that enables the containment bag assembly 10 to function as described herein.

Referring to FIGS. 3, 4, and 6, each support strap 20 includes an elongated body 34 having opposite support strap ends and a third connection member 36 slidably coupled to each of the support strap ends. In particular, each end of the elongated body 34 is looped through a respective third connection member 36 to provide a sliding arrangement therebetween, which enables adjustment of the span of length of the support strap 20 as the support strap 20 attaches to the container 12, as described further herein. In the example embodiment, the third connection member 36 includes a female component of the first releasable snap-fit connector assembly and is configured to releasably attach to the first connection member 42. Alternatively, the third connection member 36 may include any component of a releasable connector assembly that enables the first connection member 42 and the third connection member 36 to interconnect. The elongated body 34 is fabricated from any suitable material but is preferably fabricated from a flexible woven webbing material.

The support strap 20 is configured to extend over the industrial equipment, such as the electrical transformer 70, contained within the interior chamber 24 of the container 12. The support strap 20 is a load-bearing strap assembly, such that the support strap 20 supports the container 12 on the industrial equipment in the interior chamber 24 when the equipment is lifted.

In the exemplary embodiment, the cover 14 is formed substantially complementary to the container 12, such that the cover 14 may snuggly mate with the container 12, covering and closing the open top of the container 12. The cover 14 includes a top wall 60 and a downwardly extending upright wall 61. In the exemplary embodiment, the upright wall 61 is multisided, although certain aspects of the invention contemplate the upright wall being a generally tubular, continuous wall. As depicted in FIGS. 1-3, the upright wall 51 includes four (4) downwardly extending upright walls 62, 64, 66, and 68. The upright walls 62, 64, 66, and 68 terminate in a lower edge 69, which defines an open bottom of the cover 14. The cover 14 may be fabricated from any suitable material. In the example, the cover 14 is preferably fabricated from a transparent liquid-resistant flexible material, such as a transparent heavy-duty synthetic resin material, and is substantially leak proof. Functions of the cover 14 include entirely covering the open top of the container 12, providing visibility through the transparent cover 14 into the interior of the bag without lifting the cover, and providing weatherproofing of the bag contents. As used herein, the term “weatherproofing” includes protecting the interior space of the container 12 (and any industrial, equipment contained therein) from the elements, i.e. rain, wind, water, ice, snow, sun, etc. In an embodiment, the cover 14 is configured to function at a temperature down to and including negative forty degrees Fahrenheit (−40° F.).

In the exemplary embodiment, the top wall 60 and the upright walls 62, 64, 66, and 68 are formed from a single blank of sheet material. The upright walls 62, 64, 66, and 68 are folded with respect to the top wall 60 at an angle of about ninety degrees (90°) to define downwardly extending upright walls relative to the top wall 60. As depicted in FIG. 4, edges of adjacent upright walls are attached to each other to form the cover 14. For example, a first edge of the upright wall 62 may be attached to an adjacent first edge of the upright wall 64 to form a leak-proof seam 90, a second edge of the upright wall 64 may be attached to an adjacent first edge of the upright wall 66 to form a leak-proof seam 92, a second edge of the upright wall 66 may be attached to an adjacent first edge of the upright wall 68 to form a leak-proof seam 94, and a second edge of the upright wall 68 may be attached to an adjacent second edge of the upright wall 62 to form a leak-proof seam 96.

While described above as being fabricated from a single blank of sheet material, it is noted that the cover 14 may alternatively be fabricated from a plurality of blanks. For example, the top wall 60 may be separate from the upright wall 61, such as the upright walls 62, 64, 66, and 68. In such an embodiment, the top wall 60 may be attached to each of the upright walls 62, 64, 66, and 68 at a leak-proof seam in a substantially similar manner as the upright walls are attached to each other, as described above. Additionally, the top wall and/or any of the upright walls may be fabricated from multiple blanks of sheet material, wherein the blanks are attached together at one or more leak-proof seams to form the respective top wall or upright wall.

While the cover 14 is described above as a separate, complementary cover to the container 12, it is noted that in some embodiments, the cover may be formed integrally with the container 12. For example, an edge of the top wall 60 or lower edge of one of the upright walls 62, 64, 66, and 68 may be formed integrally with at least a portion of the upper edge 59 of the container 12, thereby defining a flexible joint or living hinge. In this manner, the container and the cover may be formed from a single blank of sheet material and/or multiple blanks attached together at one or more leak-proof seams. The enables the cover 14 to swing open to cover/uncover the open top of the container 12.

In the example embodiment, the leak-proof seams 90, 92, 94, and 96 are formed in substantially the same manner as the seams of the container 12. For example, the leak-proof seams 90, 92, 94, and 96 may be formed by heat welding, fusion bonding, stitching, adhesive bonding, and/or by any other method that enables the cover 14 to function as described herein.

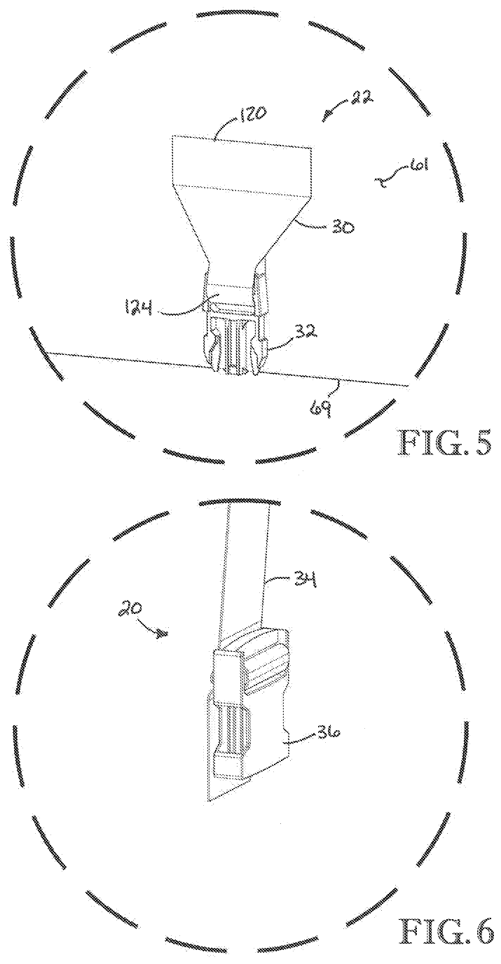

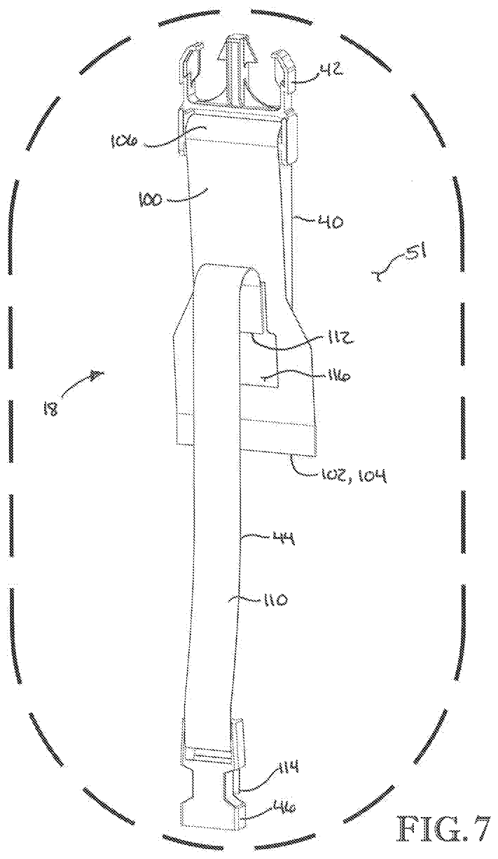

Referring to FIGS. 1-5, each two-stage connection assembly 16 also includes a cover strap 22 attached to the cover 14. The cover straps 22 are configured to releasably couple to the attachment straps 40 to removably connect the cover 14 to the container 12. Each cover strap 22 is attached to the upright wall 61 of the cover 14. In the exemplary embodiment, each of the upright walls 62, 64, 66, and 68 have at least one cover strap 22 attached thereto. Each cover strap 22 is generally vertically aligned with a respective container connection assembly 18.

Each cover strap 22 is formed from an elongated looped body 30 having first and second ends 120 and 122. As illustrated in FIG. 4, the second end 122 is looped through a fourth connection member 32, defining a loop 124 generally intermediate the first and second ends 120 and 122. The second end 122 is attached to the elongated body 30 proximate the first end 120 by heat welding, fusion bonding, stitching, adhesive bonding, and/or by any other method that enables the cover 14 to function as described herein. Similarly, the first end 120 is secured to the upright wall 61 by heat welding, fusion bonding, stitching, adhesive bonding, and/or by any other method that enables the cover 14 to function as described herein. In the example embodiment, the elongated body 30 is fabricated from any suitable material but is preferably fabricated from the same material as the container 12 (i.e., a liquid-resistant flexible material, such as a heavy-duty synthetic resin material).

The fourth connection member 32 is captured by and slidable relative to the loop 124 defined by the looped body 30. In the example embodiment, the fourth connection member 32 includes a male component of the second releasable snap-fit connector assembly and is configured to releasably attach to the second connection member 46. Alternatively, the fourth connection member 32 may include any component of a releasable connector assembly that enables the fourth connection member 32 and the second connection member 46 to interconnect.

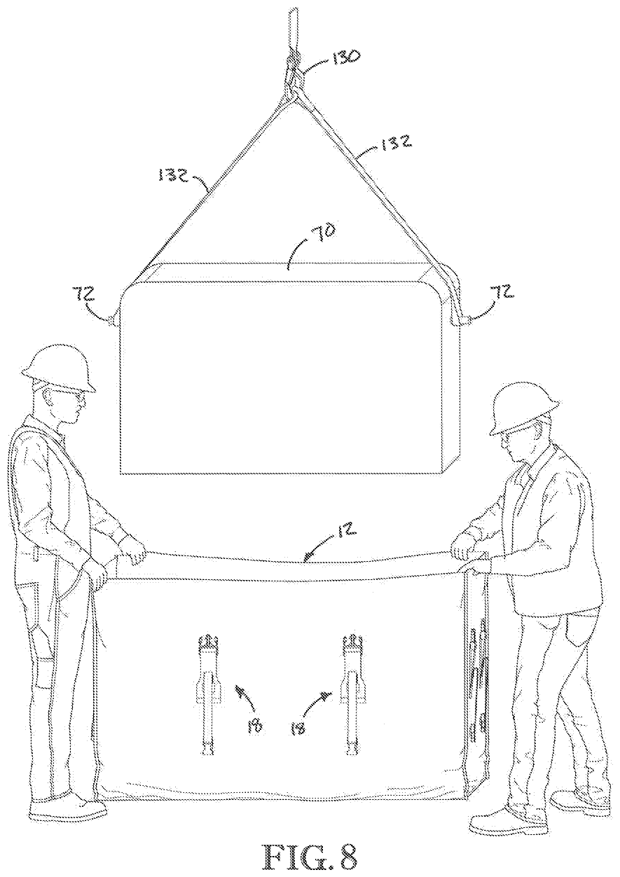

In operation, to effectively contain, lift, and transport the electrical transformer 70 (i.e., the industrial equipment) within the industrial equipment containment bag assembly 10, the transformer 70 is placed in the open top container 12. To facilitate lifting and moving the transformer 70, the transformer 70 has a pair of opposed, outwardly-extending lifting elements 72 (FIGS. 8 and 9). Placing the transformer 70 into the container 12 includes moving the transformer 70 through the open top (defined by the upper edge 59 of the container) and into the interior chamber 24 of the container 12 using one or more lifting straps 132 connected to the lifting elements 72. Generally, a single hook 130 engages the lifting straps 132. The hook 130 is connected to a further lifting arrangement (not shown) to allow lifting and handling of the electrical transformer 70 and the industrial equipment containment bag assembly 10 attached thereto. After the transformer 70 is placed into the container 12, the lifting strap(s) is 132 disconnected from the lifting element(s) 72.

After the transformer 70 is placed into the interior chamber 24 and the lifting strap 132 is disconnected, the container 12 is coupled to the transformer 70 so that the transformer 70 supports the container 12 when the transformer 70 is lifted. In particular, one or more support straps 20 are extended over a top surface of the transformer 70. The support straps 20 are releasably connected to the container 12, for example, by removably coupling the first connection member 42 associated with the container 12 and a third connection member 36 associated with the support strap 20. After the support straps 20 are connected to the container 12, the span of length of the support straps 20 may be adjusted as needed, for example, by tightening or loosening the elongated body 34 relative to the third connection members 36.

During lifting and manipulation of the transformer 70 after the container 12 is attached thereto, it will be appreciated that, owing to the construction of the support straps 20, these straps bear the weight of the container 12 and any liquid, materials, or contaminants contained therein. As noted above, in a most preferred embodiment, the container 12 is configured to hold a minimum of nine hundred pounds (900 lbs.) of liquid, materials, or contaminants while remaining securely attached to the electrical transformer 70. It will be observed that during lifting of the electrical transformer 70, the container 12 (and any liquid or other contaminants therein) is simply attached to the transformer 70 via the support straps 20. The lifting mechanism does not engage the container 12 at all. Thus, the support straps 20 bear essentially all of the load of any liquid or other contaminants that may have leaked from the transformer 70.

Preferably, after securing the support straps 20 to the container 12, the transformer 70 and the open top of the container 12 are covered with the cover 14. The cover 14 is secured to the container 12 by connecting a first number of connection locations. For example, each of the cover straps 22 are releasably connected to the container 12, for example, by removably coupling a fourth connection member 32 associated with the cover straps 22 and a second connection member 46 associated with the container 12. After the cover straps 22 are connected to the container 12, the span of length of the connection straps 44 may be adjusted as needed, for example, by tightening or loosening the elongated bodies 110 relative to the second connection members 46. This facilitates providing complete weather protection for the transformer 70, for example, by providing a sufficient amount of overlap between the upright walls 62, 64, 66, and 68 of the cover 14 and the upright walls 52, 54, 56, and 58 of the container 12. Thus, the container 12 covers a lower portion of the transformer 70 and the cover 14 covers an upper portion of the transformer 70 while engaging with the container 12 in an overlapping manner, thereby cooperatively providing weather protection to the transformer 70. The transformer 70 may be stored in an outdoor environment without concern for any leaking materials or liquid escaping from the container 12 and while being protected from the elements. It is noted that the generally flexible upright walls 52, 54, 56, and 58 of the container 12 and the upright walls 62, 64, 66, and 68 of the cover 14 are sized to provide a sufficient amount of overlap therebetween while accommodating industrial equipment of various heights. For example, where a piece of industrial equipment extends above the upper edge 59 of the container, within a predetermined amount, the upright walls 62, 64, 66, and 68 of the cover 14 are sized to provide a sufficient amount of overlap with the upright walls 52, 54, 56, and 58 of the container 12. Alternatively, where a piece of industrial equipment projects below the upper edge 59 of the container, within a predetermined amount, the upright walls 52, 54, 56, and 58 of the container 12 fold over or alongside the industrial equipment. The upright walls 62, 64, 66, and 68 of the cover 14 then provides a maximum amount of overlap of upright walls 52, 54, 56, and 58 of the container 12.

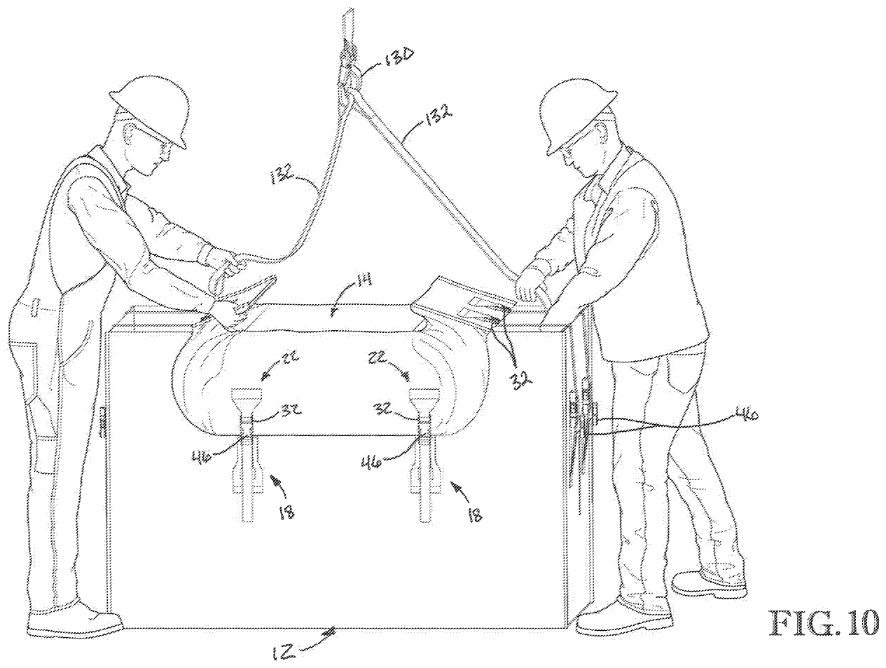

In order to subsequently move the transformer 70 without removing the industrial equipment containment bag assembly 10, the cover 14 is preferably only partially unsecured from the container 12. For example, less than all the cover straps 22 are disconnected from the container 12. In one suitable embodiment, as depicted in FIG. 10, the cover straps 22 located at opposite sides of the containment bag assembly 10 may be disconnected. Disconnecting the cover straps includes disconnecting a fourth connection member 32 associated with the cover straps 22 and a second connection member 46 associated with the container 12. Thus, the cover 14 may be disconnected from the container 12 along less than all the sides of the container. A portion of the cover may then be pulled back over the open top of the container 12, partially uncovering the transformer 70 to provide access to the lifting element(s) 72. According to some aspects of the invention, however, all cover straps 22 may be disconnected from the container 12 so that the cover 14 is entirely unsecured from the container 12.

After the transformer 70 is partially uncovered, thereby exposing one or more of the lifting elements 72, a lifting strap 132 may be connected to the lifting element(s) 72, for example, by extending the lifting strap 132 through the partially uncovered open top of the container 12. The lifting strap(s) 132 may then be coupled to the hook 130 and the transformer 70, and therefore the containment bag assembly 10, may be lifted and moved, for example, to a new location. The transformer 70 may be placed in a new location.

After placing the transformer 70 in place, the lifting strap(s) 132 may be disconnected from the lifting element(s) 72. The cover 14 may be extending back over the transformer 70 and the partially uncovered open top of the container. The cover straps 22 that were disconnected may be re-connected to the container 12, for example, by removably coupling a fourth connection member 32 associated with the disconnected cover straps 22 and a second connection member 46 associated with the container 12. This ensures that the cover 14 is re-secured to the container 12, thereby providing weatherproofing to the transformer.

As described herein, the container 12 is preferably not configured to withstand substantial loads associated with support of the transformer 70. By supporting the container 12 on the transformer 70 with the support straps 20, and by providing access to the lifting elements 72 while keeping the cover 14 at least partially attached, the container 12 is not required to carry the load of the transformer 70. Rather, the container 12 acts as a contaminant or liquid containment unit and/or shield, with the support straps 20 only bearing the weight of the container and that of any liquid or other contaminants collected therein.

### Additional Considerations

Features of one or more embodiments described above may be used in various combinations with each other and/or may be used independently of one another. For instance, although a single disclosed embodiment may include a preferred combination of features, it is within the scope of certain aspects of the present invention for the embodiment to include only one (1) or less than all of the disclosed features, unless the specification expressly states otherwise or as might be understood by one of ordinary skill in the art. Therefore, embodiments of the present invention are not necessarily limited to the combination(s) of features described above.

Although the disclosure has been described with reference to the embodiments illustrated in the attached figures, it is noted that equivalents may be employed, and substitutions made herein, without departing from the scope of the disclosure as recited in the claims.

The preferred forms of the invention described above are to be used as illustration only and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and access the reasonably fair scope of the present invention as pertains to any apparatus not materially departing from but outside the literal scope of the invention set forth in the claims.

Having thus described various embodiments of the disclosure, what is claimed as new and desired to be protected by Letters Patent includes the following:

What is claimed is:

1. A method to contain and facilitate lifting of industrial equipment having a lifting element, said method comprising the steps of:
(a) placing the equipment in an open top container of a containment bag assembly;
(b) coupling the container to the equipment so that the equipment supports the container when the equipment is lifted;
(c) covering the equipment and open top of the container with a cover;
(d) securing the cover to the container so as to cooperatively provide weather protection to the equipment;
(e) un-securing the cover from the container; and
(f) partially uncovering the equipment and open top so that the lifting element is exposed.

2. The method of claim of 1, further comprising the steps of:
(g) after step (f), lifting the equipment and thereby the container;
(h) after step (g), re-covering the equipment and open top; and
(i) re-securing the cover to the container.

3. The method of claim 2,
step (g) including the step of connecting a lifting strap to the lifting element.

4. The method claim 3,
said step of connecting the lifting strap to the lifting element including the step of extending the lifting strap through the partially uncovered open top of the container,
step (g) including the step of disconnecting the lifting strap from the lifting element before steps (h) and (i) are performed.

5. The method of claim 1,
step (a) including the steps of moving the equipment through the open top and into an interior of the container using a lifting strap connected to the lifting element, and disconnecting the lifting strap from the lifting element.

6. The method of claim 1,
step (b) including the step of extending a support strap over the equipment.

7. The method of claim 6,
step (b) further including the step of releasably connecting the support strap to the container.

8. The method of claim 1,
step (d) including the step of connecting the cover to the container at a first number of connection locations,
step (e) including the step of disconnecting the cover from the container at a second number of the connection locations, wherein the second number is less than the first number.

9. The method of claim 8,
said container being multisided, with at least one of the connection locations being positioned along each of the sides,
step (e) including the step of disconnecting the cover from the container along less than all the sides.

10. The method of claim 1,
step (b) including the step of extending a support strap over the equipment.
step (b) further including the step of releasably connecting the support strap to the container,
said step of releasably connecting the support strap to the container including the step of removably coupling a first connection member associated with the container and a third connection member associated with the support strap,
step (d) including the step of connecting the cover to the container at a first number of connection locations,
step (e) including the step of disconnecting the cover from the container at a second number of the connection locations, wherein the second number is less than the first number,
said connection locations each including a second connection member associated with the container and a fourth connection member associated with the cover,
step (d) including the step of removably coupling the second and fourth connection members of the first number of connection locations,
step (e) including the step of removably decoupling the second and fourth connection members of the second number of the connection locations.

11. The method of claim 10,
steps (a) through (f) being performed in sequence.

12. An equipment containment bag assembly to contain and facilitate lifting of
industrial equipment, said equipment containment bag assembly comprising:
a container having an interior chamber and an open top through which the industrial equipment passes into the interior chamber, said container including—
a base wall,
an upright wall extending upwardly from the base wall, and
a connection assembly including an attachment strap connected to the upright wall;
a support strap configured to extend over the equipment when in the interior chamber,
said support strap being releasably coupled to the attachment strap to removably connect the support strap to the container, such that the support strap supports the container on the equipment in the interior chamber when the equipment is lifted; and
a cover removably covering the open top of the container,
said cover including a cover strap releasably coupled to the attachment strap to removably connect the cover to the container.

13. The equipment containment bag assembly of claim 11,
said attachment strap comprising an elongated looped body having opposite first and second attachment strap ends, both of which are attached to the upright wall.

14. The equipment containment bag assembly as claimed in claim 13,
said connection assembly including a connection strap releasably coupled to the cover strap,
said connection strap being attached to the attachment strap.

15. The equipment containment bag assembly as claimed in claim 14,
said connection strap being attached to the elongated looped body between the attachment strap ends.

16. The equipment containment bag assembly as claimed in claim 15,
said connection strap comprising an elongated body having opposite first and second connection strap ends, one of which is one or more of heat welded, fusion bonded, stitched, and adhesive bonded to the elongated looped body.

17. The equipment containment bag assembly as claimed in claim 14,
each of said support strap and said connection strap comprising a flexible woven webbing material.

18. The equipment containment bag assembly as claimed in claim 12,
said container and said cover comprising a liquid-resistant flexible material.

19. The equipment containment bag assembly as claimed in claim 12,
said attachment strap including a first connection member,
said connection assembly including a connection strap that includes a second connection member,
said support strap including a third connection member,
said cover strap including a fourth connection member,
said first and third connection members being releasably coupled,
said second and fourth connection members being releasably coupled.

20. The equipment containment bag assembly as claimed in claim 19,
said first and third connection members being releasably coupled via a snap-fit connection,
said second and fourth connection members being releasably coupled via a snap-fit connection.

21. The equipment containment bag assembly as claimed in claim 19,
said first and third connection members being removably covered by the cover.
